(19) United States
(12) Patent Application Publication
(10) Pub. No.: US 2014/0282029 A1
(43) Pub. Date: Sep. 18, 2014

(54) Visual Presentation of Customized Content

(71) Applicant: Yahoo! Inc., Sunnyvale, CA (US)

(72) Inventor: Eric Vishria, San Carlos, CA (US)

(73) Assignee: Yahoo! Inc., Sunnyvale, CA (US)

(21) Appl. No.: 13/797,320

(22) Filed: Mar. 12, 2013

(51) Int. Cl. H04L 29/08

(52) U.S. Cl. CPC H04L 29/0809
USPC 715/738

(57) ABSTRACT

Customized content is presented to a user in a browser. A plurality of content items are determined and ranked for the user. The plurality of content items include user-specific content and general content, each content item associated with one or more tags. The content items are presented to the user in a layout of tiles with each tile displays a content item. After a user selection of a tag is received, content items are filtered based on the user selected tag and presented to the user in a new layout.

### CROSS REFERENCE TO RELATED APPLICATIONS

This application is related to U.S. patent application Ser. No. 12/698,064, which is incorporated herein by reference.

### BACKGROUND

The disclosure generally relates to the field of providing customized online content for Internet browsing.

When using a web browser application to navigate content on the Internet, a user can directly enter a Uniform Resource Locator (URL) and direct the web browser to fetch and display content from the website associated with the URL. Often, web browsers allow the user to save particular URLs of interest so the user may quickly access the same URLs in the future. The user may also search for content with a query to a search engine and examine the search results. In addition, the user can configure a home page for the browser so that when the user opens the browser window, the browser is directed to the page. Some websites, such as a web portal, can bring together information from various sources and provide links to other websites for the general public or a specific user. In all cases, the browser depends on the user to know what content is interesting to the user and to direct the browser accordingly. Some browsers use the frequency and/or recency of a user's prior visit to a website as a heuristic for judging the relative interest of that website to the user, and display frequently visited sites for easy access.

Conventional browsers fail to participate in the process of content discovery except as a passive utility, directed by the user. Thus, users often delegate content discovery to a particular website, such as a social networking site. Such a site uses various signals to determine what content might be interesting to the user, such as the source of the content, who posted it, other users' reactions to the content, the subject of the content, the user's previous history of viewing, clicking on, and reacting to other content, among other factors. Even if a particular website does explicitly include such information, the information is limited to interactions with the content on that particular website and does not include interactions with the content via other websites or services.

The browser is in the unique position of being able to use the totality of a user's web browsing experience to facilitate content discovery.

### SUMMARY

Embodiments for customizing content for a user are described herein. In one embodiment, a user provides textual input, such as a search term, to a browser. User-specific content associated with the user input is determined to be of likely potential interest to the user from websites that the user visited, bookmarked, searched, and shared, as well as from the user's social network connections and declared interests. General content is also determined and associated with the user input. General content may include content that is selected based on objective criteria rather than user-specific criteria, such as matching a search term and/or a global popularity metric. For example, the general content may include trending topics on the web that match the user's search term. The determined user-specific content and general content are then ranked so that top ranked content items are selected for presentation to the user. A tile is associated with each of the plurality of content items for displaying the title, source and media included in the content item. The location of each tile is determined based on the rank of the content item associated with the tile and on the freshness of the tile's content. A layout is generated comprising the tiles with the plurality of content items and displayed in the user's browser.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

FIG. 1 is a block diagram of a computing environment for Internet browsing with customized content according to one embodiment.

FIG. 2 is a block diagram illustrating an example architecture of a browser in the computing environment according to one embodiment.

FIG. 3 is a block diagram illustrating an example architecture of an application server in the computing environment according to one embodiment.

FIG. 4 is a trace diagram illustrating a method for determining customized content and layout for a user according to one embodiment.

FIG. 5 is a flowchart illustrating a method for determining layout of the customized content according to one embodiment.

FIG. 6A is a screenshot illustrating an example user interface for presenting customized content based on user input according to one embodiment.

FIG. 6B is a screenshot illustrating an example user interface for presenting a preview of customized content based on content source according to one embodiment.

FIG. 7A is a screenshot illustrating an example user interface for presenting customized content as a start page according to one embodiment.

FIG. 7B is a screenshot illustrating an example user interface for presenting customized content in a tile with an inner bar according to one embodiment.

FIG. 7C is a screenshot illustrating an example user interface for presenting a preview of customized content based on content tag according to one embodiment.

### DETAILED DESCRIPTION

The computing environment described herein enables user content customizations in a web browser application. The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

### System Environment

Referring to FIG. 1, a high-level block diagram of a computing environment 100 for Internet browsing with customized content, comprises a client 102 with a browser 108, an application server 104, a content server 106, and a network 120. The client 102 is a computing device with a processor and a memory capable of running applications like browser 108. Examples of client 102 include a desktop, a laptop, a tablet and a handheld computing device. The network 120 represents the communication pathways between the client 102, the application server 104 and the content server 106. In one embodiment, the network 120 is the Internet. The network 120 may also include dedicated or private communications links that are not necessarily part of the Internet.

The application server 104 is a computing system with a processor and a memory that receives and stores user data associated with users' browsing activity. The application server 104 determines customized content for users based on the received user data and transmits the customized content to browser 108 on the client 102. In one embodiment, the application server 104 identifies sources of the content customized for the user, such as by analyzing the user data and tracking the sites that the user visits. Alternatively, the application server 104 prompts the user to designate a list of content sources that the user frequents. The application server 104 can also identify the user's friends on social networking platforms, by either implicitly observing the user's online activity, or explicitly by querying the social networking sites for the user's friends. The application server 104 can then identify a list of content sources based on the online activities of the user and the user's friends. Once the content sources are identified, the application server 104 instructs the content server 106 to fetch content from the identified content sources. The application server 104 then organizes the fetched content in a customized layout and transmits the fetched content in its customized layout to the browser 108 for displaying to the user. In an alternative implementation, the application server 104 sends the content to the browser where its layout is customized and displayed.

The content server 106 is a computing device with a processor and a memory that stores online content like web pages, audio or video streams, and social network content, etc. The content server 106 receives the content sources identified by the application server 104 for a particular user. The content server 106 then fetches and stores the content as instructed by the application server 104. Upon receiving instructions from the application server 104, the content server 106 transmits the stored content over network 120 to the application server 104 or the client 102. In one embodiment, the content server 106 only fetches and caches content needed to generate a preview of the content, and it may also modify or filter the content to save only the portion needed for the preview generation. The content server 106 may be implemented on a same system or on different systems from the application server 104.

The browser 108 is an application for retrieving, presenting, and traversing online content available from various sites including the application server 104 and the content server 106. Additionally, the browser 108 stores data on users' browsing activity and transmits the data to application server 104. The browser 108 also receives customized content for users from the application server 104 and the content server 106, and presents the customized content in a layout of previews to the user.

A user launches the browser 108 on the client 102 and provides authentication information to the browser 108. The browser 108 receives user input and authenticates the user. In one embodiment, the browser 108 maintains a user authentication database (not shown) and the browser verifies the user's authentication information against the authentication information saved in the user database. In another embodiment, the browser 104 transmits the user's authentication information to the application server 104. The application server 104 authenticates the user and then transmits the authentication results to the browser 108.

After the user is authenticated, the browser 108 tracks the user's activities as the user browses the web, stores user data associated with the user activity, and transmits the tracked user data to the application server 104. The application server 104 determines customized content for the user based on the received user data. The browser 108 receives content customized for the user in a layout of previews from the application server 104 and the content server 106, and presents the content to the user.

In one embodiment, the customized content for the user includes user-specific and general content. The user-specific content is determined to be of potential interest to the user based on online activities of the user. Content that potentially interests the user may come from websites that the user visited, bookmarked, searched, and shared, as well as from the user's social network connections. The general content, on the other hand, includes content that may be of interest to the general public and not necessarily related to the user, like trending topics. As such, the general content is not derived from the user's online activities. The user-specific content and general content may be ranked by various ranking criteria, such as the user's interest level and content freshness.

In one embodiment, the application server 104 organizes the customized content into a customized layout. The layout of previews created by the application server 104 and transmitted to the browser 108 for presentation comprises multiple separate areas called “tiles” in the browser window, where each tile contains a piece of customized content. The preview of the content presents information about the content, such as title, abstract, source, and age of the content. The layout can be displayed to the user as a start page of the browser 108, or in response to a textual input of the user, filtered by the user input. This layout of preview provides the user a gateway to the Internet with customized content including not only the user-specific content of potential interest to the user, but also the general content that may be of interest to the users of the browser 108.

The description about the browser 108, the content server 106, and the application server 104 assigns particular functions to one entity or another. This description and the function assignment are for illustration purposes and do not limit the server or the client to their assigned functions. Upon reading this disclosure, one of ordinary skill in the art will understand that functions described in one embodiment as being performed on the server side can also be performed on the client side in other embodiments if appropriate. Similarly, the client side functions can be performed by the server if appropriate. Additionally, the functionality attributed to a particular component can be performed by different or multiple components operating together, as deemed appropriate by the implementer.

### Browser

FIG. 2 is a block diagram illustrating an example architecture of the browser according to one embodiment. The browser 108 comprises an authentication module 203, a user specified data module 204, an inferred data module 206 and a user interface module 208. Other embodiments may include different or additional modules.

The authentication module 203 receives the authentication data from the user and authenticates the user. The authentication data comprises user identification and optionally a corresponding password. In one embodiment, the authentication module 203 stores authentication data for one or more users and the authentication module 203 verifies the authentication data received from the user against the stored authentication data. In another embodiment, the authentication module 203 transmits the authentication data to application server 104 or another authenticating entity (not shown) and receives a verification result of the authentication data.

In one embodiment, the authentication module 203 also registers new users. In this embodiment, the authentication module 203 prompts the user for desired username and password or other credentials. Additionally, in one embodiment, the authentication module 203 prompts the user for information about one or more user's social networking profiles. The authentication module 203 transmits the received information to application server 104.

After the authentication module 203 authenticates the user, the user specified data module 204 and inferred data module 206 start collecting information about the user's interaction with the browser 108. Because the information is collected after the user's authentication, data modules 204-206 associate the collected information with the user's browsing activities or browsing patterns. In one embodiment, the browser 108 does not include the authentication module 203, the user is not authenticated, and the data modules 204 and 206 still associate the collected information with the user's browsing activities or browsing patterns. In this case, the data modules 204 and 206 treat all users of browser 108 as one common user and associate the collected information with that common user's browsing activities or browsing patterns.

The user specified data module 204 receives and stores data that user inputs in the browser 108 or in widgets associated with the browser 108. For example, the user specified data module 204 receives the website addresses the user inputs, the search terms the user enters in a search toolbar or a search web page, the login information the user enters in a social networking website or a social networking widget, the information the user enters in forms or shopping orders on a website, or any other information entered by the user in widgets associated with the browser 108 or pages presented by the browser 108. In one embodiment, the user specified data module 204 also stores the frequency with which the user accesses the same web page, searches the same search term, enters the same login information or enters the same information on a web page or a widget. In another embodiment, the user specified data module 204 also tracks and stores the amount of time the user spends on a particular website like a gaming website or a social networking website. The user specified data module 204 repeatedly transmits all or part of its stored information to the application server 104, which uses the received information to determine content customizations for the user.

The inferred data module 206 infers additional data associated with the user based on the user specified data. In one embodiment, the inferred data module 206 searches for and stores the embedded links in the web pages accessed by the user. In another embodiment, the inferred data module 206 determines the user's friends through an API provided by the user's social networking site. The inferred data module 206 then searches and saves embedded links on the web pages of the user's friends as part of the user data. The inferred data module 206 repeatedly transmits all or part of its stored information to the application server 104, which uses the received information to customize content for the user.

The user interface module 208 provides an interface between the user and the application server 104. In one embodiment, the user interface module 208 receives a user input from an omnibox of the browser. The omnibox is a user interface element that combines the functionality of two separate elements: the address bar for user input of website address or URL and the search bar for search terms. One of the benefits of the omnibox in the browser 108 is to show dynamic results. For example, while the user is typing a URL or a search term in the omnibox, the user interface module 208 transmits the user input to the application server 104. The application server 104 then searches for relevant content based on the current user input and transmit early results to the user interface module 208 for display in the browser window. As the user is typing characters one by one in the omnibox, the search results displayed in the browser window change dynamically along with the user input. In one embodiment, the relevant content is searched from the Internet and the user's social network and ranked by the application server 104 using various criteria, such as the user's online activity, declared interests, friend's activity, and editorial judgment. The user interface module 208 presents the search results of relevant content according to the rankings.

FIG. 6A is a screenshot illustrating an example user interface for presenting customized content based on user input according to one embodiment. In FIG. 6A, a user types “Te” in the omnibox 602 on the top of the browser window. The user interface module 208 receives a layout of preview of the customized content created by the application server 104 based on the user input “Te” and renders it to the user. The customized content is organized into two columns of mosaic tiles (hereinafter referred to as “tiles”), with each tile representing an item of content. A column 610 on the left contains general content customized for the user, such as suggested GOOGLE search term for the current user input “Te” in tile 612 and a website “Techcrunch.com” in tile 614. A right column 620 includes user-specific content from the user's social network connections, such as a friend's information on FACEBOOK in tile 622, a webpage tile the user is following in tile 624, and a post from TWITTER subscribed by the user in tile 626. Note that the user-specific content and the general content may be displayed in the same column instead of being displayed in separate columns as illustrated in FIG. 6A.

FIG. 6B is a screenshot illustrating an example user interface for presenting a preview of customized content based on content source (i.e. customized content sorted by content source or customized content from a particular content source) according to one embodiment. A view of the content based on source can be created when the user clicks on the tile 624 in FIG. 6A to preview the content originated from the website TechCrunch. In FIG. 6B, the content from this website is presented in a temporal order from the latest item to older items. A time stamp for each item is shown at the bottom of the tile indicating the time lapse since the content was first published. Content shared by the user's friends is also tagged, for example, tiles 632 and 634 each bear a top bar showing the friend's name and a “LIKE” tag (other reaction tags are also possible). In addition, tiles representing top-ranked content contain photos, such as tiles 632 and 636. Similarly, clicking on a person's photo, such as the photos in tiles 622 and 626, can generate content view with content posted by and/or related to the person (not shown).

### Application Server

Referring now to FIG. 3, which is a block diagram illustrating an example architecture of the application server according to one embodiment. The application server 104 comprises a user data module 304, a content customization module 306, and a content layout module 308. Other embodiments may include different or additional modules.

The user data module 304 manages user data associated with users of the browser 108. The user data module 304 repeatedly receives user data from the user specified data module 204 and the inferred data module 206 of the browser 108. Accordingly, the user data module 304 stores the data received directly from a user and the data inferred by the browser 108 about the user. Additionally, in one embodiment, the user data module 304 also stores the authentication information for various users. Accordingly, the user data module 304 stores a username and optionally a password for the user.

The content customization module 306 analyzes the user data managed by the user data module 304 and determines content customized for the user based on its user data analysis. In one embodiment, the customized content for the user is displayed when user types in the omnibox of the browser 108, or on a start page presented by the browser 108 after the user launches the browser 108. The content determined by the content customization module 306 includes user-specific as well as general content. In one embodiment, the content customization module 306 comprises a user-specific content module 312, a general content module 314, and a content ranking module 316. Other embodiments may include different or additional modules.

On today's Internet, the overwhelmingly large amount of content are not only categorized and classified by content publishers using tags to indicate the types or categories of information contained, such as technology, science, arts, sports, travel, jobs, and gadgets, etc., but also shared and grouped by the content consumers with reaction tags indicating the consumers' reaction to the content, such as ‘LIKE’, ‘WOW’, ‘WTF’, and ‘LOL’. Furthermore, the content can also be tagged, explicitly or implicitly, by the content customization module 306 based on hash values, sources, types, and other properties of the content. In one embodiment, the user-specific content module 312 and the general content module 314 searches and filters the content based on these tags to determine content that match the user's interest and content items to present to the user.

Sources of content that interests the user include websites that the user visited, bookmarked, searched, and shared. The user-specific content module 312 thus searches for such websites from the user data, which includes user's browsing history, browser bookmarks, and URL links embedded in user emails, messages, and posts. In one embodiment, the user-specific content can be obtained by re-executing user's saved queries. In one embodiment, the user-specific content module 312 retrieves previous search data, such as the exact query terms and search engines used by the user, from the user data module 304 and repeats the queries to obtain updated search results. The user-specific content module 312 can acquire additional content by executing the saved searches on various search engines and search services including social networking platforms for aggregated results. The search results may contain web links, textual documents, messages, and multimedia content. The system and method for executing saved searches are described in U.S. patent application Ser. No. 12/698,064.

The user-specific content module can also derive user-specific content from the user's social network connections. Social networks provide social content of a number of diverse types including web links, news stories, pictures, music, videos, personal updates, mini blogs, and forum posts from social networking websites like FACEBOOK or TWITTER. In one embodiment, the social content specific to a user can be mined from online activity data of the user's friends. For example, once the user's friends and/or groups (hereinafter referred to as “friends”) to which the user is affiliated are identified, the user-specific content module 312 can retrieve content from the friends' homepages on the social networking websites. In addition, if the friends are the users of the customized content browser described herein, their user data of online interactions can also be analyzed to determine customized content for the user.

In one embodiment, the user-specific content module 312 determines user-specific content dynamically when user launches the browser to ensure the freshness of the content. Alternatively, the user-specific content can be determined offline when the browser 108 is closed. In this case, the content can be refreshed periodically so that latest content can be presented to the user. When the user starts the browser 108 and passes the authentication, latest customized content specific to the user is determined and provided by the user-specific content module 312. FIG. 7A is a screenshot illustrating an example user interface for presenting customized content as a start page when the user launches the browser according to one embodiment. Instead of displaying a regular homepage from a single website, the content shown in FIG. 7A includes TWITTER feeds specific to the user and content about the user's interest, in addition to latest political news and technical trends. The user may click any tile to access additional details of the content represented by the tile, or start typing in the omnibox on the top of the browser window to refine the customization. In response to a textual input, the customized content is filtered to match the user input, as illustrated in FIG. 6A.

Referring back to FIG. 3, the general content module 314 determines general content, which is not determined based on the user's online activities. For example, the general content may cover trending topics not necessarily related to user. The general content can be brought together from diverse sources; it could be a viral video on YOUTUBE, a racy post on TWITTER, a web sensation, or shocking news. In one embodiment, the general content module 314 retrieves the trending topics from the web and caches them on the content server 106. The cached general content can be maintained for an amount of time like a few days or a couple of weeks. Similar to the user-specific content, the determined general content can be presented to the user on the start page or in response to the user input, filtered by the user input.

The content ranking module 316 ranks the content determined by the user-specific content module 312 and general content module 314. Both the user-specific content and general content can be ranked by various ranking criteria. In one embodiment, the user-specific content is ranked by the user's interest, or a likelihood that the user is going to select certain content. Ranking of the user's interest can be explicitly specified by the user, or implicitly derived from the user's history of interaction with the various type of content. For example, user-specific content, such as technology news and electronic gadgets, can be ranked based on the frequency with which the user visits various websites for the content during a period of time. If a user visits a website at least once a day, the content ranking module 316 considers the content associated with that website more relevant than the content collected from other websites that the user frequents only once a week. As another example, the user-specific content can be ranked by the amount of time the user spends on a website that provides the content. Content associated with a website where the user spends hours per visit is ranked higher than content on a website where the user browses through in a couple of minutes in a visit.

The likelihood that the user selects certain content also depends on the type and source of the content. For example, users may prefer content embedded with photos and videos than pure text. Thus, the content ranking module 316 can award the content including rich media a better ranking than those without. In addition, for the user-specific content from social networks, content can be ranked, for example, by how closely the user is associated with the friends who shared the content, and/or the reputation of the information source within the social networks.

In one embodiment, general content is ranked by the content ranking module 316 based on the popularity and/or freshness of the content. For example, content such as internet events and political news can be ranked based on a temporal order from the latest to not-so-recent content. As another example, the popularity of a piece of content can be evaluated by the number of websites and/or friends that are interacting with the content—the more people talk about it, the higher the ranking of the content. The content ranking module 316 can also rank the general content using other criteria, such as a ranking provided by search engines and search services. In one embodiment, the content ranking module 316 ranks the user-specific content and general content using the same criterion, such as the freshness or age of the content.

After the content is ranked, a certain number of content items can be selected from top ranked user-specific content and top ranked general content. The content layout module 308 associates each of the selected top ranked content items with a tile for presentation. A tile is an area in the browser window dedicated to the associated content, which may comprise a top bar 702 showing the title, friend name, or abstract of the content. A tile may also include an optional photo or video 704, and a bottom bar 706 indicating the source and age of the content, as shown in FIG. 7A. In one embodiment, the width of the tiles is fixed and the height of the tiles varies depending on the content rankings. This design allows tiles of fixed width to be arranged into one or more columns of the same width within the browser screen. Additionally, rankings of the content are differentiated by the height of the tiles, with higher ranked content associated with taller tiles. Other factors may also affect the tile size, such as media type of content (e.g., user-specific, general, promotional ads, and suggested search terms).

The number of the user-specific content items and the number of general content items in a browser window layout may vary from time to time. The content layout module 308 may select the same or different numbers of items from both categories depending on the content availability, user preferences, and/or system configurations. In one embodiment, the number of tile columns is determined by the size of the browser screen. For example, there are two columns of tiles in the layout shown FIG. 7A. In case the user turns the screen to landscape orientation or moves from a tablet to a desktop monitor, three or more columns can be arranged, whereas on a mobile phone, tiles can be organized into a single column. Furthermore, the height of the tiles can be defined as multiples of a basic unit. For example, in FIG. 7A, tiles 712 and 714 are one basic unit long, while tile 716 is two basic units long. Among other benefits, this common denominator basic unit in the tiles' heights beneficially enables displaying tiles such that the top or bottom edges of tiles in one column are more likely to match the top or bottom edges of tiles in another column. The matching edge between adjacent tiles in two columns makes it easier for a user to shift focus between two adjacent tiles.

In one embodiment, tiles in the same columns can be ordered according to the rankings of the content presented in the tiles. Alternatively, tiles can be put together based on the age of the content in the tile. In other embodiments, positions of the tiles can be based on aesthetical design, such as the matching height between the pair of tiles 712 and 714 and the tile 716 in FIG. 7A.

Once the layout is created by the content layout module 308, the content and the layout are transmitted to the browser 108 for presentation to the user. Besides the preview with a layout of content filtered by source described above in FIG. 6B, a layout with content filtered by tag can be selected by clicking on the strip 708 between the photo bar 704 and bottom bar 706 as illustrated in FIG. 7A. Once clicked, the tile is opened to show an inner tag bar 722 as illustrated in FIG. 7B, which is a screenshot illustrating an example user interface for presenting customized content in a tile with an inner bar according to one embodiment. The tag bar 722 contains tags associated with the content in the tile as well as social reaction tags, such as “LIKE” and “WOW”. A preview of content filtered by tag can be created when the user clicks one of the tags inside the tag bar 722. For example, selecting the “Technology” tag brings a preview of content filtered by the tag 732 illustrated in the FIG. 7C, which is a screenshot illustrating an example user interface for presenting a preview of customized content filtered by content tag according to one embodiment. All the tiles presented in FIG. 7C represent content associated with the same “Technology” tag.

### Content Customization Methodology

FIG. 4 is a trace diagram illustrating a method for determining customized content and layout for a user according to one embodiment. In the described embodiment, the method steps involve the client 102 and the application server 104. However, some or all of the steps may be performed by other entities in other embodiments. Likewise, other embodiments may include different and/or additional steps than the ones described herein.

In step 402, the browser 108 receives and transmits user input, such as a search term, to the application server 104. The browser 108 transmits the user input to the application server 104 repeatedly as the browser 108 receives new user input. The application server 104 receives the user input in step 404. Next, in step 406, the application server 104 determines and ranks user-specific content related to the received user input. The application server 104 then determines and ranks the general content related to the received user input in step 408. In step 410, the application server 104 determines and transmits a layout including ranked user-specific and general content to the browser 108. The application server 104 performs steps 404-410 repeatedly as the application server 104 receives new input from the browser 108. After receiving the layout including the ranked content in step 412, the browser 108 displays the user-specific and general content related to the received user input.

As mentioned above, the functionality of the browser 108 and the application server 104 has been described for illustration purposes and the above described functionality can be implemented either in the browser 108 or the application server 104. For example, the application server 104 is illustrated above as including the user data module 304, the content customization module 306 and the content layout module 308. In one embodiment, these modules 304-308 are included in the browser 108. Accordingly, the authentication module 203 authenticates the user, and the data modules 204 and 206 collect information about the user's browsing history or browsing patterns and pass the collected information to the user data module 304 in browser 108. The content customization module 306 in browser 108 analyzes the user data in user data module 304 and determines the content customizations for the user, and the content layout module 306 in browser 108 generates a preview layout with tiles for presentation to the user.

FIG. 5 is a flowchart illustrating a method for determining layout of the customized content according to one embodiment. In the described embodiment, the steps of the method are performed by the application server 104. However, some or all of the steps may be performed by other entities in other embodiments. Likewise, other embodiments may include different and/or additional steps than the ones described herein.

In step 502, the application server 104 determines the content including user-specific and general content for the user. For example, the content may be prepared for the start page, or based on the user input. The application server 104 then ranks the content in step 504. As disclosed above, the ranking of the content can be based on the user's interest. To determine a layout of the customized content for the user, the application server 104 allocates tiles to the top-ranked content in step 506. Next, in the step 508, the application server 104 determines the location of each tile within the layout based on the rank of the content to be presented in the tile. For example, tiles can be put into a temporal order if the content is ranked based on the freshness of the content. In step 510, the application server 104 determines a size for each tile based on the type of content to be present in the tile. Once the size for each tile is determined, the application server 104 organizes the title, source, and media included in the content in the tile. The application server subsequently creates the layout with tiles of determined sizes in determined location, including their respective content in step 512 and in step 514, transmits the layout to the browser 108 for presentation to user.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for presenting customized content to a user, the method comprising:
determining a plurality of content items for display to a user, each content item associated with one or more tags;
presenting the plurality of content items in a first layout of tiles in a web browser to the user, each content item displayed in a tile;
receiving a user selection of a tag associated with a presented content item in a tile;
determining a set of content items comprising content items associated with the user selected tag;
presenting the set of the content items associated with the user selected tag in the web browser to the user.

2. The method of claim 1, further comprising:
receiving a user selection of one of the plurality of content items; wherein
the one or more tags associated with one of the plurality of content items is presented in response to receiving the user selection of one of the plurality of content items.

3. The method of claim 2, further comprising:
presenting expansion of tile associated with the selected one of the plurality of content items; wherein
the one or more tags associated with the one of the plurality of content items is presented in the expanded tile.

4. The method of claim 1, wherein the plurality of content items comprising user-specific content and general content.

5. The method of claim 1, wherein each tile is a rectangle area displaying a preview of the associated content item including title, abstract, photos, source, and tags of the content.

6. The method of claim 1, further comprising:
ranking the plurality of content items based on the user's interest; and
generating the first layout and second layout of tiles based on the rankings of the content items displayed in each tile.

7. The method of claim 1, wherein the first layout and second layout each comprises one or more rows or columns of the tiles.

8. The method of claim 1, wherein the one or more tags include content tags indicating categories of information contained in the content item or reaction tags indicating the user's reaction to the content.

9. The method of claim 8, wherein the content tags associated with a content item includes at least one from a group of: news, technology, science, arts, sports, travel, style, entertainment, jobs, and gadgets.

10. The method of claim 1, wherein the one or more tags include implicit tags determined from hash values, sources, or information categories of the content items.

11. A non-transitory computer-readable storage medium storing executable computer program instructions for presenting customized content to a user, the computer program instructions comprising instructions for:
determining a plurality of content items for display to a user, each content item associated with one or more tags;
presenting the plurality of content items in a first layout of tiles in a web browser to the user, each content item displayed in a tile;
receiving a user selection of a tag associated with a presented content item in a tile;
determining a set of content items comprising content items associated with the user selected tag;
presenting the set of the content items associated with the user selected tag in the web browser to the user.

12. The storage medium of claim 11, wherein the computer program instructions further comprising instructions for:
receiving a user selection of one of the plurality of content items; wherein
the one or more tags associated with one of the plurality of content items is presented in response to receiving the user selection of one of the plurality of content items.

13. The storage medium of claim 12, wherein the computer program instructions further comprising instructions for:
presenting expansion of tile associated with the selected one of the plurality of content items; wherein
the one or more tags associated with the one of the plurality of content items is presented in the expanded tile.

14. The storage medium of claim 11, wherein the plurality of content items comprising user-specific content and general content.

15. The storage medium of claim 11, wherein each tile is a rectangle area displaying a preview of the associated content item including title, abstract, photos, source, and tags of the content.

16. The storage medium of claim 11, wherein the computer program instructions further comprise instructions for:
ranking the plurality of content items based on the user's interest; and
generating the first layout and second layout of tiles based on the rankings of the content items displayed in each tile.

17. The storage medium of claim 11, wherein the first layout and second layout each comprises one or more rows or columns of the tiles.

18. The storage medium of claim 11, wherein the one or more tags include content tags indicating categories of information contained in the content item or reaction tags indicating the user's reaction to the content.

19. The storage medium of claim 18, wherein the content tags associated with a content item includes at least one from a group of: news, technology, science, arts, sports, travel, style, entertainment, jobs, and gadgets.

20. The storage medium of claim 11, wherein the one or more tags include implicit tags determined from hash values, sources, or information categories of the content items.
